(19) United States
(12) Patent Application Publication
(10) Pub. No.: US 2024/0403075 A1
(43) Pub. Date: Dec. 5, 2024

(54) APPLICATION STATE MANAGEMENT FOR ELECTRONIC DEVICES

(71) Applicant: Apple Inc., Cupertino, CA (US)

(72) Inventors: John R. HASS, San Francisco, CA (US); Omid KHALILI, Santa Clara, CA (US); Praveen Gowda Ippadi Veerabhadre Gowda, San Jose, CA (US)

(21) Appl. No.: 18/385,882

(22) Filed: Oct. 31, 2023

Related U.S. Application Data
(60) Provisional application No. 63/470,953, filed on Jun. 4, 2023.

(51) Int. Cl. G06F 9/451

(52) U.S. Cl. CPC G06F 9/451

(57) ABSTRACT

Aspects of the subject technology provide application state management for electronic devices. An electronic device may provide application state management by maintaining a state of a physical environment of the electronic device, monitoring the operating modes of one or more applications running on the electronic device, and providing compacted updates to the state of the physical environment to the one or more applications according to the operating modes. In an example, the electronic device may provide, to an application, a compacted set of updates that occurred while an application was in a background mode, when the application returns to an active or foreground mode.

### CROSS REFERENCE TO RELATED APPLICATIONS

This application claims the benefit of priority to U.S. Provisional Patent Application No. 63/470,953, entitled, “APPLICATION STATE MANAGEMENT FOR ELECTRONIC DEVICES”, filed on Jun. 4, 2023, the disclosure of which is hereby incorporated herein in its entirety.

### TECHNICAL FIELD

The present description relates generally to extended reality environments including, for example, application state management for electronic devices.

### BACKGROUND

Electronic devices can concurrently run multiple applications. However, when multiple applications are running, one of the applications is typically active to receive user inputs, and the other applications are suspended or running in a background mode and do not receive user inputs.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example system architecture including various electronic devices that may implement the subject system in accordance with one or more implementations.

FIG. 2 illustrates an example computing device that may implement aspects of the subject technology.

FIG. 3 illustrates an example use case in which multiple applications are running in an extended reality environment in accordance with one or more implementations.

FIG. 4A illustrates an example use case in which virtual content from a first application is displayed in an extended reality environment while a second application runs in a background mode in accordance with one or more implementations.

FIG. 4B illustrates an example use case in which virtual content from a second application is displayed in the extended reality environment of FIG. 4A while the first application runs in a background mode in accordance with one or more implementations.

FIG. 4C illustrates an example use case in which the physical environment that forms a portion of the extended reality environment of FIG. 4A is modified while the first application runs in a background mode in accordance with one or more implementations.

FIG. 4D illustrates an example use case in which the first application of FIG. 4A is returned to an active or foreground mode and displays virtual content based on a subset of the updates to the physical environment that occurred while the first application was in the background mode in accordance with one or more implementations.

FIGS. 5A and 5B illustrate various examples of compacting a set of updates to physical environment information that occur while an application is in a background mode in accordance with one or more implementations.

FIG. 6 illustrates a flow diagram of an example process for application state management according to aspects of the subject technology.

FIG. 7 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Implementations of the subject technology described herein provide for efficient distribution of physical environment information to one or more applications running on an electronic device. In devices such as laptop and desktop computers having two-dimensional monitors that display application content in two-dimensions over a flat, computer-generated background such as a desktop screen, applications are generally self-contained and do not receive or utilize information about the desktop screen or the surrounding physical environment for displaying information. However, in, for example, XR devices (e.g., devices capable of displaying XR scenes), applications may generate and/or place content (e.g., virtual content) based on physical environment information that indicates the current state of the physical environment around the XR device.

In use cases in which an application running on an XR device has been running in a background mode (e.g., a suspended mode) for a period of time and returns to an active mode (e.g., a foreground mode), the application may need to be apprised of any changes that have occurred in the physical environment while the application was in the background mode, in order, for example, to update the locations and/or other aspects of application-generated virtual content accordingly. One option for providing these updates to an application would be to continuously provide all of the updates to the physical environment that are detected by the device to all applications running on the device irrespective of the mode of the applications. However, this can be an inefficient use of processing and communications resources within the device, to provide physical environment information to applications that are not actively using that information. Another option for providing these updates to an application would be to store all of the updates to the physical environment that are detected by the device while an application is in a background mode, and provide all of the updates to the application when the application returns to an active mode. However, this can be an inefficient use of device memory resources as, (i) particularly in XR use cases, storing all updates to the physical environment can use large amounts of memory as the device moves within the physical environment, and (ii) providing all of the updates to the applications can cause the applications to unnecessarily utilize processing resources to process all of the updates.

Aspects of the subject technology may provide a reduced set of physical environment updates to an application that has been in the background for a period of time and has returned to an active state. For example, in the active state, the application may use physical environment information to display virtual content. By compacting physical environment updates that occur while the application is in the background state, the amount of data stored for the application (and to be provided to the application upon return to the active state) can be reduced. Physical environment updates can include, as examples, updates to physical anchors used by the application to anchor virtual content, updates to scene reconstruction meshes, textures, locations, and/or any other information describing the physical environment.

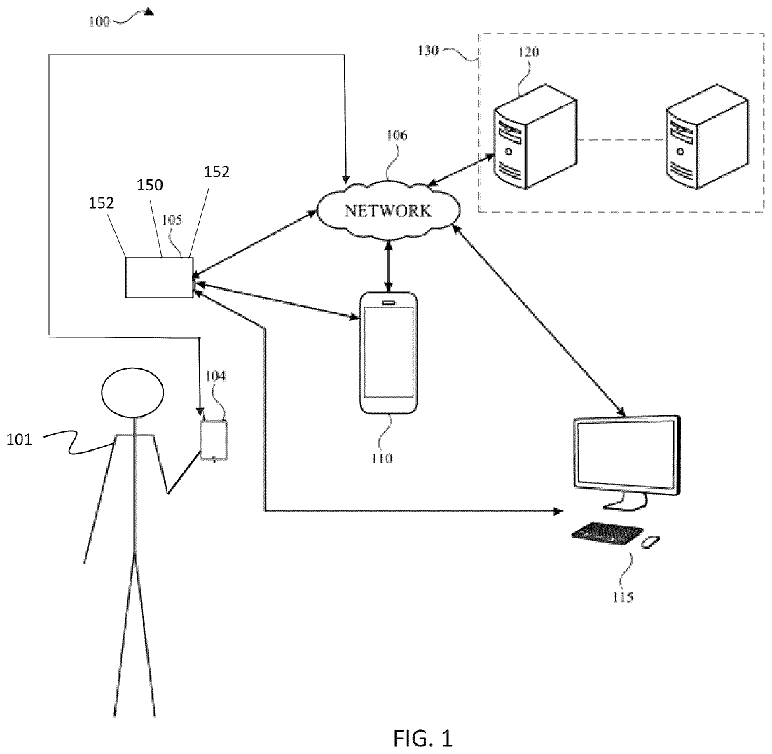

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, an electronic device 110, an electronic device 115, and a server 120. For explanatory purposes, the system architecture 100 is illustrated in FIG. 1 as including the electronic device 105, the electronic device 110, the electronic device 115, and the server 120; however, the system architecture 100 may include any number of electronic devices and any number of servers or a data center including multiple servers.

The electronic device 105 may be smart phone, a tablet device, or a wearable device such as a head mountable portable system, which includes a display system capable of presenting a visualization of an extended reality environment to a user 101. The electronic device 105 may be powered with a battery and/or any other power supply. The battery may be integrated with the electronic device 105 and/or a separate battery may be coupled to the electronic device 105 (e.g., by a cable or other wired or wireless connection to provide power to the electronic device 105). In an example, the display system of the electronic device 105 provides a stereoscopic presentation of the extended reality environment, enabling a three-dimensional visual display of a rendering of a particular scene, to the user. In one or more implementations, instead of, or in addition to, utilizing the electronic device 105 to access an extended reality environment, the user may use an electronic device 104, such as a tablet, watch, mobile device, and the like.

The electronic device 105 may include one or more cameras such as camera(s) 150 (e.g., visible light cameras, infrared cameras, etc.) Further, the electronic device 105 may include various sensors 152 including, but not limited to, cameras, image sensors, touch sensors, microphones, inertial measurement units (IMU), heart rate sensors, temperature sensors, Lidar sensors, radar sensors, sonar sensors, GPS sensors, Wi-Fi sensors, near-field communications sensors, etc.) Moreover, the electronic device 105 may include hardware elements that can receive user input such as hardware buttons or switches. User input detected by such sensors and/or hardware elements correspond to various input modalities for interacting with virtual content displayed within a given extended reality environment. For example, such input modalities may include, but not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. The electronic device 105 may also detect and/or classify physical objects in the physical environment of the electronic device 105.

The electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power limitations of the electronic device 105 such as available battery power of the device. In response to power limitations, the electronic device 105 may deactivate certain sensors within the device itself to preserve battery power.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 and/or providing power to the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an implementation, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the extended reality environment in a real-time manner. In an example, the electronic device 105 provides a rendering of a scene corresponding to the extended reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The electronic device 105 may also detect events that have occurred within the scene of the extended reality environment. Examples of such events include detecting a presence of a particular person, entity, or object in the scene. Detected physical objects may be classified by electronic device 105, electronic device 110, and/or electronic device 115 and the location, position, size, dimensions, shape, and/or other characteristics of the physical objects can be used to provide physical anchor objects for an XR application generating virtual content, such as for a UI of an application, for display within the XR environment. The electronic device 105 may generate scene understanding information, three-dimensional meshes, textures, and the like based on images from camera(s) 150 and/or sensor data from sensor(s) 152.

It is further appreciated that the electronic device 110 and/or the electronic device 115 can also generate such extended reality environments either working in conjunction with the electronic device 105 or independently of the electronic device 105.

The network 106 may communicatively (directly or indirectly) couple, for example, the electronic device 105, the electronic device 110 and/or the electronic device 115 with the server 120 and/or one or more electronic devices of one or more other users. In one or more implementations, the network 106 may be an interconnected network of devices that may include, or may be communicatively coupled to, the Internet.

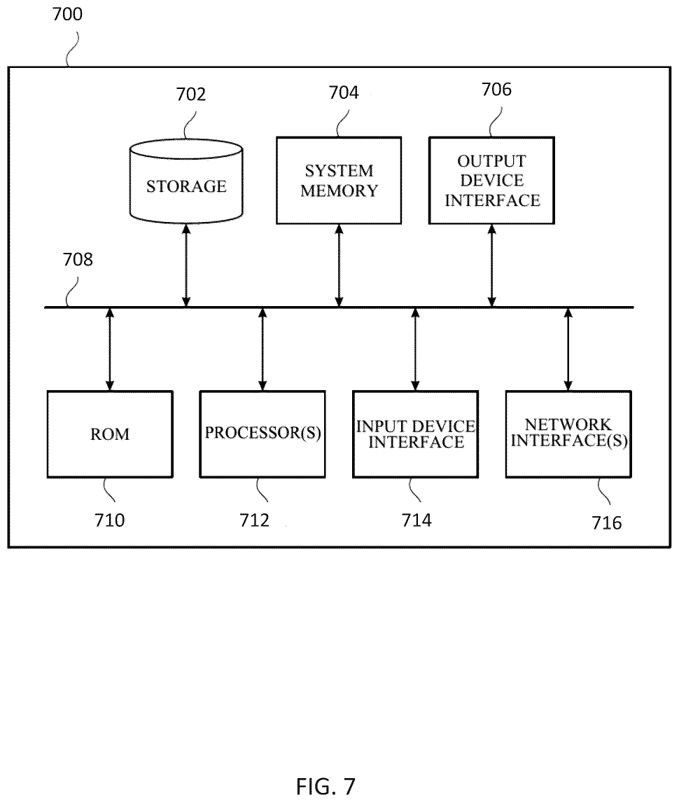

The electronic device 110 may include a touchscreen and may be, for example, a smartphone, a portable computing device such as a laptop computer, a peripheral device (e.g., a digital camera, headphones), a tablet device, a wearable device such as a watch, a band, and the like, any other appropriate device that includes, for example, one or more processors, memory, and/or communications circuitry for communicating with other devices over wired or wireless connections. In one or more implementations, the electronic device 110 may not include a touchscreen but may support touchscreen-like gestures, such as in an extended reality environment. In one or more implementations, the electronic device 110 may include a touchpad. In FIG. 1, by way of example, the electronic device 110 is depicted as a mobile smartphone device with a touchscreen. In one or more implementations, the electronic device 110, the electronic device 104, and/or the electronic device 105 may be, and/or may include all or part of, the electronic system discussed below with respect to FIG. 7. In one or more implementations, the electronic device 110 may be another device such as an Internet Protocol (IP) camera, a tablet, or a peripheral device such as an electronic stylus, etc.

The electronic device 115 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an implementation, the server 120 may function as a cloud storage server that stores any of the aforementioned extended reality content generated by the above-discussed devices and/or the server 120.

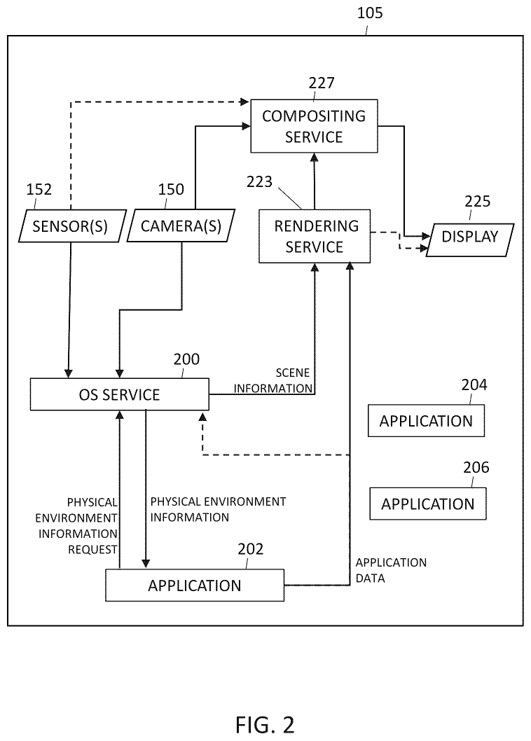

FIG. 2 illustrates an example architecture that may be implemented by the electronic device 105 in accordance with one or more implementations of the subject technology. For explanatory purposes, portions of the architecture of FIG. 2 are described as being implemented by the electronic device 105 of FIG. 1, such as by a processor and/or memory of the electronic device; however, appropriate portions of the architecture may be implemented by any other electronic device, including the electronic device 110, electronic device 115, and/or server 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 2 can be implemented in software or hardware, including by one or more processors and a memory device containing instructions, which when executed by the processor cause the processor to perform the operations described herein. For example, in FIG. 2, the trapezoidal boxes may indicate that the sensors 152, the camera(s) 150 and the display 225 may be hardware components, and the rectangular boxes may indicate that the OS service 200, the application 202, the rendering service 223, and the compositing service 227 may be implemented in software, including by one or more processors and a memory device containing instructions, which when executed by the processor cause the processor to perform the operations described herein.

In the example of FIG. 2, an application such as application 202 provides application data to a rendering service 223 for rendering of the application data, such as a UI of the application and/or other virtual content. The application data may include application-generated content (e.g., windows, buttons, tools, characters, animations, etc., which may be two-dimensional and/or three-dimensional content) and/or user-generated content (e.g., text, images, etc.), and information for rendering the content (e.g., as virtual content in an XR scene or XR environment). In one or more implementations, rendering service 223 renders the application data for display by a display such as display 225 of the electronic device 105. In one or more other implementations, the application 202 may render some or all of its own content, and may provide rendered application content to the rendering service 223 and/or to the compositing service 227 to generate display content for display by a display 225. As shown in FIG. 2, the electronic device 105 may include one or more additional applications, such as application 204, and application 206. In the example of FIG. 2, application 204 and application 206 may each be in a background mode, a suspended mode, another inactive mode or a terminated mode, in which the applications are not provided content to the rendering service 223 for display or receiving information from the OS service 200.

As shown in FIG. 2, additional information may be provided for display of the application data from the application 202, such as in a two-dimensional or three-dimensional (e.g., XR) scene. In the example of FIG. 2, sensors 152 provide sensor information (e.g., depth information from one or more depth sensors, motion information from one or more motion sensors, and/or user information) to an OS service 200 (e.g., an XR service that may be provided by an operating system of the electronic device 105). Camera(s) 150 may also provide images of a physical environment and/or one or more portions of the user (e.g., the user's eyes, hands, face, etc.) to OS service 200. OS service 200 may generate, using the sensor information and/or images from the sensors 152 and/or camera(s) 150, physical environment information, such as a three-dimensional mesh, identifiers of one or more physical anchor objects (e.g., horizontal planar surfaces, vertical planar surfaces, tables, chairs, floors, walls, and/or other physical objects), locations of one or more physical anchor objects, texture information, lighting information, and/or other information describing, some or all of the physical environment of electronic device 105. As shown in FIG. 2, the OS service 200 may also generate scene information, such as depth information and/or object information for a portion of the physical environment of the electronic device 105, and may provide the scene information to the rendering service 223 and/or the compositing service 227 for use in rendering and/or integrating virtual content (e.g., as described by the application data) from the application 202.

In various examples, any of the application 202, the application 204, and/or the application 206 may be a gaming application, a media player application, a content-editor application, a training application, a simulator application, or generally any application that provides a UI or other content for display at a location that depends on the physical environment, such as by anchoring the UI or other content to an anchor in the physical environment. Application 202, application 204, and/or application 206 may include code that, when executed by one or more processors of electronic device 105, generates application data, for display of a UI or other virtual content of the application on, near, attached to, or otherwise associated with a physical anchor in the physical environment of the electronic device 105.

In one or more implementations, once the application data has been generated, the application data can be provided to the OS service 200 and/or the rendering service 223, as illustrated in FIG. 2. As shown, scene information can also be provided to rendering service 223. The scene information can include or be based on, as examples, sensor information such as a depth map of the physical environment, and/or object information for detected objects in the physical environment. Rendering service 223 can then render the application data from application 202 for display by display 225 of electronic device 105. The UI or other virtual content of application 202 may be rendered for display at an appropriate location on the display 225, to appear to a user to be at a location, remote from the display 225, in the physical environment of the electronic device 105. Display 225 may be, for example, an opaque display, and camera(s) 150 may be configured to provide a pass-through video feed to the opaque display. The UI or other virtual content may be rendered for display at a location on the display corresponding to the displayed location of a physical anchor object in the pass-through video. Display 225 may be, as another example, a transparent or translucent display. The UI or other virtual content may be rendered for display at a location on the display corresponding to a direct view, through the transparent or translucent display, of the physical anchor object.

As shown, electronic device 105 can also include a compositing service 227 that composites video images of the physical environment, based on images from camera(s) 150, for display together with the rendered UI or other virtual content from the rendering service 223 and/or the application 202. For example, compositing service 227 may be provided in an electronic device 105 that includes an opaque display, to provide pass-through video to the display. In an electronic device 105 that is implemented with a transparent or translucent display that allows the user to directly view the physical environment, compositing service 227 may be omitted or unused in some circumstances, or may be incorporated in rendering service 223. Although the example of FIG. 2 illustrates a rendering service 223 that is separate from OS service 200, it should be appreciated that OS service 200 and rendering service 223 may form a common service and/or that rendering operations for rendering content for display can be performed by the OS service 200. Although the example of FIG. 2 illustrates a rendering service 223 that is separate from application 202, it should be appreciated that, in some implementations, application 202 may render content for display by display 225 without using a separate rendering service.

Electronic device 105 may allow, upon authorization by a user of the electronic device, application 202 to request and obtain physical environment information from OS service 200 (e.g., via an application programming interface (API) or via a Serial Peripheral Interface (SPI)) as illustrated in FIG. 2, which can facilitate efficient development, implementation, and/or run-time execution of application 202 (e.g., since each application does not have to perform its own object detection, scene mapping, anchoring, tracking, etc.) as well as intuitive placement and/or behavior of virtual objects in the XR environment. In one or more implementations, the OS service 200 may maintain a global state of the physical environment (e.g., a scene reconstruction mesh, a texture, lighting information, and/or locations, orientations, sizes, shapes, meshes, textures, etc. for one or more physical anchor objects at the current time).

As illustrated in FIG. 2, application 202 may request physical environment information from the OS service 200. As examples, the physical environment information requested by an application may include a global state of the physical environment, a physical anchor object (e.g., for a specific type of physical anchor object, such as a table or a vertical planar surface), an identifier of a physical anchor object, a location of a physical anchor object, an orientation of a physical anchor object, a mesh of a physical anchor object, a full scene (e.g., 3D) mesh, texture information, lighting information, and/or other information describing the physical environment of the electronic device 105. In one or more implementations, the physical environment information request from the application 202 may be in the form of a subscription to updates to one or more types or categories of the physical environment information. For example, the application 202 may subscribe to updates to a location of a particular physical object, such as a chair, in the physical environment, to updates to a three-dimensional mesh of the physical environment, and/or to information for all physical anchor objects detected in the three-dimensional environment. As another example, another application (e.g., application 204 or application 206) running on the electronic device 105 may subscribe to updates to the three-dimensional mesh of the physical environment and lighting information (e.g., light levels and/or light directions) in the physical environment.

The physical environment information requested by the application 202 may be provided to the application 202 in an initial transfer of data (e.g., an upload of the global state of the physical environment), and, after the initial transfer of data, by providing only updates (e.g., descriptions of changes) to the physical environment information. For example, in a use case in which the physical environment information includes a physical anchor object corresponding to a physical chair, the OS service 200 may provide a mesh of the chair, a location of the chair, a texture for the chair, and lightning information for the chair to the application 202. The application 202 may then perform operations (e.g., physics modeling, rendering, shading, etc.) to generate virtual content for anchoring to the physical chair. Subsequently, the OS service 200 may detect a change in the location or orientation of the physical chair, and may provide an update to the location or the orientation of the chair (e.g., without re-providing the entire mesh for the chair) to the application 202. In this way, the amount of data being provided to the application 202 can be reduced, and the amount of computation performed by the application 202 to update the application-generated virtual content can also be reduced. For example, rather than receiving the full global state of the physical environment each time the physical environment changes (e.g., including due to changes in perspective due to the motion of the electronic device itself) and recomputing the physics modeling, rendering, shading, and/or other operations to determine how to generate virtual content for integration into the physical environment, when an application receives only updates (e.g., changes) to the previously provided global state, the application can efficiently compute corresponding updates (e.g., changes) to its virtual content.

In the example of FIG. 2, the physical environment information may be provided to the application 202, and used by the application 202 to generate the application data for display, while the application 202 is in an active mode (e.g., also referred to herein as a foreground mode in some examples). For example, in the active mode, the application 202 may be actively consuming the physical environment information and generating application data for display by the display 225 based thereon. However, at times, the application 202 may enter another state, such as an inactive mode, a background mode, a suspended mode, or a terminated mode. For example, a user of the electronic device 105 may select (e.g., using a click of a mouse, a tap on a touchscreen, a hand gesture, or a verbal input) another application that is running on the device (e.g., to bring the other application to the foreground, such as for user interaction), which may cause the application 202 to enter a background or suspended mode. In other examples, the user may minimize a UI window of an application, send a UI of an application to a dock, or close a UI window of an application.

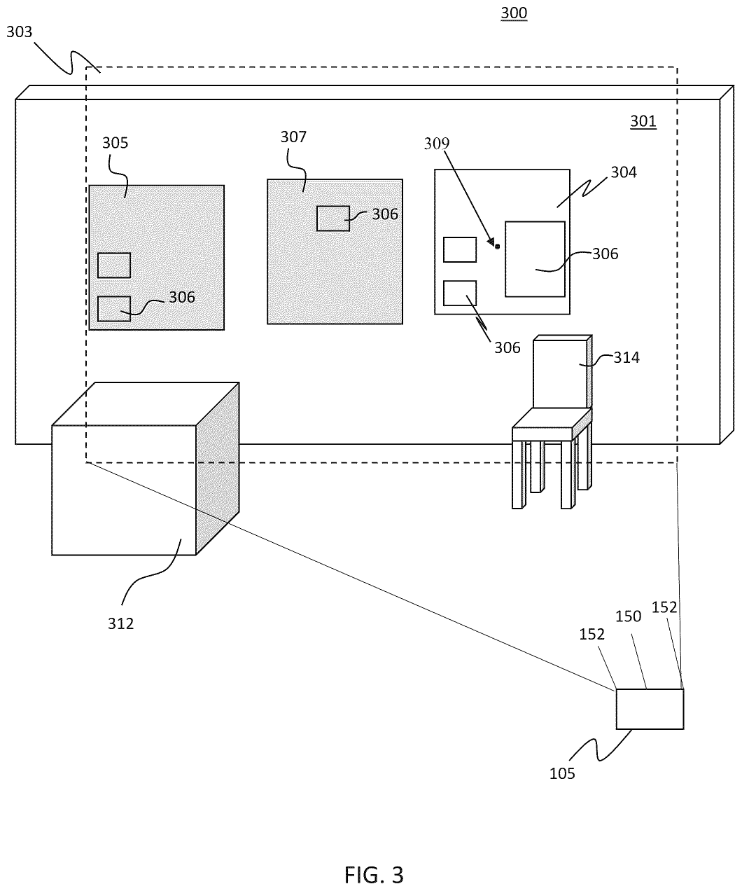

FIG. 3 illustrates an example in which the electronic device 105 displays user interfaces (UIs) of three different applications in an XR environment. For example, in one or more implementations, electronic device 105 display may a user interface (UI) 304 of an application, such as application 202, running on the device in an active mode. In this example, a user interface 305 of second application (e.g., application 204 of FIG. 2) and a user interface 307 of a third application (e.g., application 206 of FIG. 2) are also displayed in the XR environment, and may be in a background mode. In the example of FIG. 3, UI 304, UI 305, and/or UI 307 may each include one or more elements 306. Elements 306 may include text entry fields, buttons, selectable tools, scrollbars, menus, drop-down menus, links, plugins, image viewers, media players, sliders, or the like. Elements 306 may be contained within the windows of the UI 304, the UI 305, and/or the UI 307 as in the example of FIG. 3, and/or may be displayed to appear elsewhere in the physical environment.

In the example of FIG. 3, the user interface (UI) 304 (e.g., of application 202) is displayed by electronic device 105 to appear to be located at an anchor location 309 in a physical environment 300 of the electronic device 105. In this example, UI 304 is displayed in the viewable area 303 of the display of the electronic device 105 to appear as if attached to a physical wall 301 in the physical environment 300. In this example, a physical table 312 and a physical chair 314 are also present in the physical environment 300. In the example of FIG. 3, the display of the UI 304 to appear as though on the physical wall 301 can be achieved, in part, by providing up-to-date physical environment information to the application 202 regarding the state of the physical wall 301 in the physical environment 300, and its location and/or orientation relative to the electronic device 105, while the application 202 is in an active mode. In one or more implementations, while the application 202 is in the active mode, the application 202 may be provided (e.g., by OS service 200 of FIG. 2) with updates to physical environment information that describes physical attributes of the physical wall 301, the physical table 312, the physical chair 314, and/or other physical objects and/or features of the physical environment 300. In this way, the application 202 may be provided with the ability to allow a user of the electronic device 105 to move the UI 304 and/or one or more elements 306 thereof from the physical wall 301 to the physical chair 314 or to the physical table 312 at any time.

In one more implementations, the applications (e.g., applications 204 and 206) corresponding to UI 305 and UI 307, which are in a background mode, may not be provided with updates to the physical environment information. For example, in a background mode (e.g., a suspended mode or an inactive mode), an application (e.g., application 204 or application 206) may store the state of displayed application content (e.g., the states of the UI 305 or the UI 307), the state of the physical environment information, and/or any other data being used and/or displayed by the application when the application entered the background mode, but may pause or cease generating new application data and/or providing new application data to the rendering service 223, the OS service 200, and/or the compositing service 227. During the period of time in which the application 204 or the application 206 is in the background mode (which may be as short as a fraction of a second, a few seconds, a few minutes, or as long as an hour, several hours, or days) the OS service 200 may cease providing the updates to the physical environment information to the application 202.

In the example of FIG. 3, the UI 305 and the UI 307 of the application 204 and the application 206 that are in a background state, but are visible in the XR environment along with the UI 304. However, in other examples, user interfaces and/or other display content provided by an application that is in a background state may not be displayed (e.g., the display content provided by an active application may be exclusively displayed by the electronic device 105 in some modes of an application).

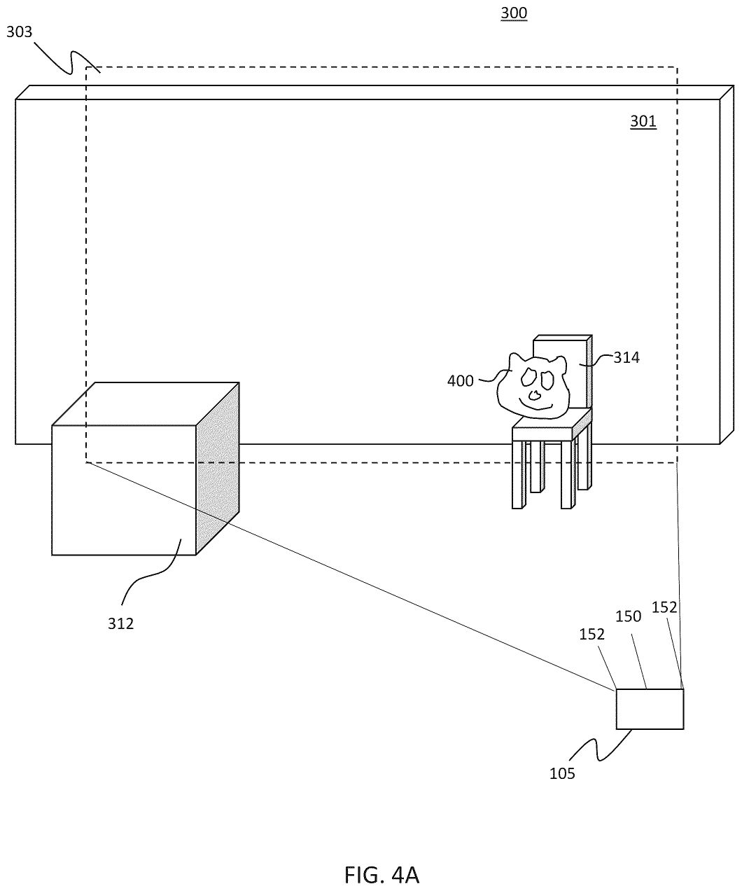

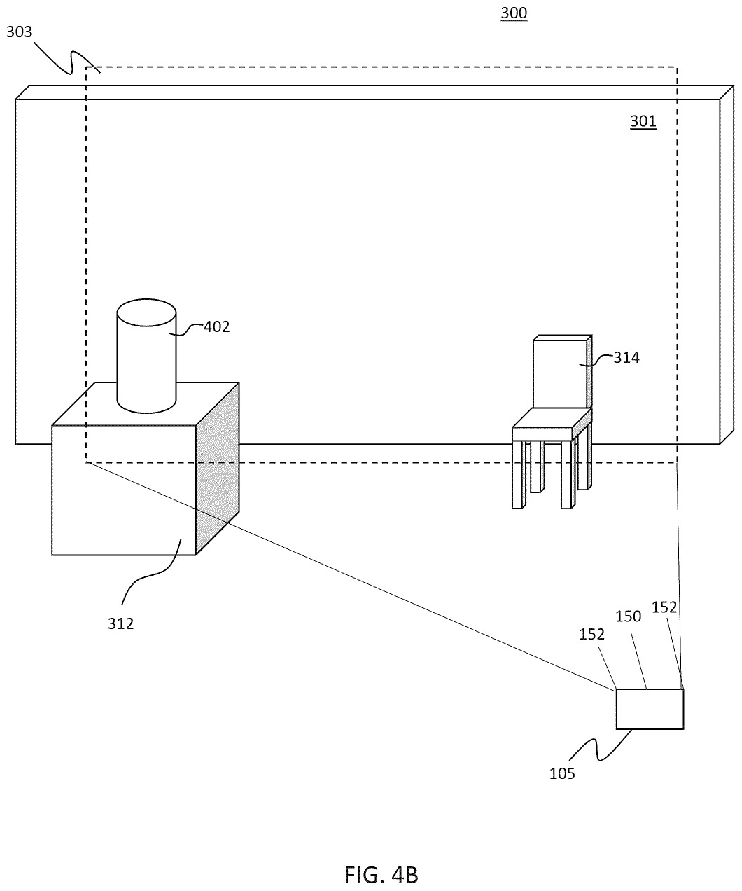

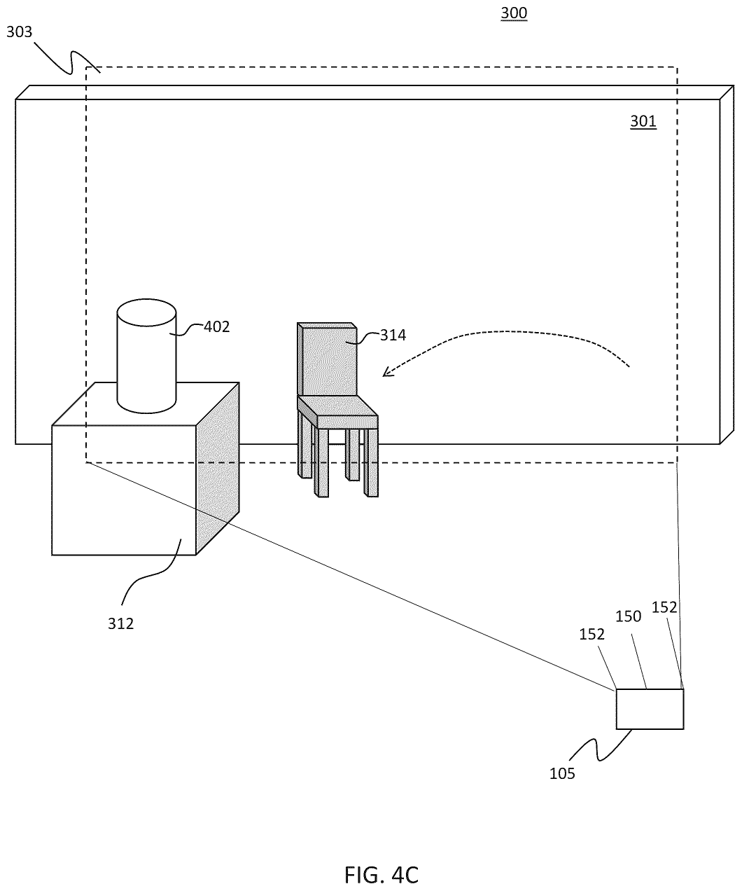

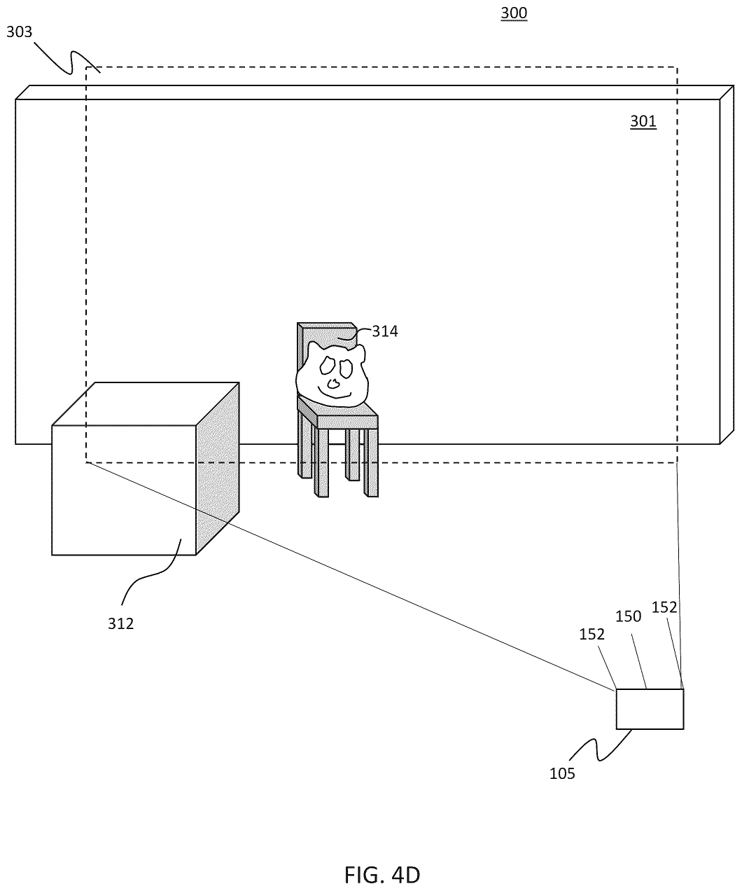

For example, FIG. 4A illustrates a use case in which virtual content 400 provided by the application 202 that is in the active mode is displayed without displaying any display content from one or more background mode applications (e.g., applications 204 and/or 206). In this example, the virtual content 400 (e.g., an implementation of an element 306 of a UI 304) is displayed without a bounding UI window, and is anchored to the physical chair 314, while the underlying application 202 is in an active or foreground mode. In this mode, the virtual content 400 may be moved by a user to any other location in the physical environment 300, such as to be anchored to the physical wall 301 or the physical table 312. In this mode, the application 202 may use ongoing updates to the physical environment information from the OS service 200 to cause the virtual content 400 to actively follow the location of the physical chair 314, relative to the location and/or orientation of the electronic device 105 as the electronic device 105 is moved by a user within the physical environment 300, and/or as the physical chair 314 is moved within the physical environment 300.

FIG. 4B illustrates a use case in which the application 202 corresponding to the virtual content 400 has entered a background mode, and another application (e.g., application 204) has entered an active mode. In this example, the virtual content 400 is no longer displayed, and virtual content 402 (e.g., different virtual content) provided by the other application is displayed. In this example, the virtual content 402 is displayed so as to appear anchored to the physical table 312. The virtual content 402 of the other application may be moved by a user to any other location in the physical environment 300, such as to be anchored to the physical wall 301 or the physical chair 314. In this mode, the virtual content 402 of the other application may also actively follow the location of the physical table 312, relative to the location and/or orientation of the electronic device 105 as the electronic device 105 is moved by a user within the physical environment 300, and/or as the physical table 312 is moved within the physical environment 300. While the virtual content 402 of the other application is displayed, the other application is in the active mode, and the application 202 is in the background mode, the application 202 may cease receiving updates to the physical environment information that describes state of the physical environment 300.

However, during the period of time in which the application 202 is in the background mode, changes in the physical environment of the electronic device 105 can occur. For example, the physical chair 314 to which the virtual content 400 was anchored while the application was active may be moved within the physical environment or removed from the physical environment (e.g., by moving the chair to another room, or by the user walking into a different room with the electronic device 105) while the application 202 is in the background mode. For example, FIG. 4C illustrates an example use case in which the physical chair 314 is moved while the application 202 is in the background mode and the other application corresponding to the virtual content 402 is in an active mode. More generally, the global 3D state of the physical environment may change (e.g., at particular times or constantly) over time (e.g., including due to motion of the electronic device 105 itself and/or physical changes to the physical environment), which means that each application that is in a background mode can have a last-stored 3D state from an earlier time, that is inconsistent with the current global 3D state. When these applications come back to the foreground, they may be synced with latest global 3D state. For example, as illustrated by FIG. 4D, when the application 202 is returned to the active mode (e.g., or a different active mode in a device or application in which various active modes are available), the virtual content 400 generated by the application 202 may be updated based on the new state of the physical environment at that time, such as by displaying the virtual content 400 anchored to the physical chair 314 at the new (e.g., moved) location of the physical chair 314.

In order to provide the application 202 with the ability to synchronize the application data (e.g., including displayed virtual content) with the new state of the physical environment when the application 202 returns to an active mode, the electronic device 105 (e.g., the OS service 200 of FIG. 2) may store the updates to the physical environment information that occurred while the application 202 was in the background mode. However, storing every update that occurs while the application 202 is in the background mode, and providing all of those updates to the application 202 may be expensive in terms of memory usage, and may cause large amounts of, potentially unnecessary, processing of the stored updates by the application 202. For example, the physical chair 314 may have been moved to one or several other locations in the physical environment 300, removed from the physical environment 300 for a period of time, and/or returned to the physical environment 300 while the application 202 was in the background mode and prior to the physical chair 314 being placed at the location shown in FIG. 4D. It may be inefficient and/or unnecessary for the electronic device 105 to store, for the application 202, all of these updates to the state of the physical chair 314 that occurred while the application 202 was in the background mode. For example, the result of the application 202 sequentially updating the virtual content 400 for each of the updates to the physical chair 314 may be the same as the result of updating the virtual content 400 for only the last (or a relevant subset) of the updates that occurred while the application 202 was in the background mode. For this reason, it may be technically advantageous in some implementations to provide an application, such as the application 202, with a reduced (e.g., minimal) number of updates with which the application can synchronize the application's previously stored physical environment information to the latest physical environment information.

One alternative to providing an application with updates to the physical environment that have occurred while the application was in a background mode, would be to provide the entire new global state of the physical environment to the application when the application returns to an active or foreground mode. However, providing the entire new global state may cause the application to re-perform physics modeling, rendering, shading, anchoring, and/or other operations that were already performed by the application for some or all of the global state prior to the application entering the background mode. This can be computationally inefficient, and can also take an amount of time that would cause delays, gaps, or glitches in the application output. Accordingly, providing a reduced number of updates as described herein can be advantageous in terms of computational efficiency and/or application latency. Moreover, providing a reduced number of updates as described herein can provide an advantage for purposes of correlating the current environment state to the environment state of when the application was paused or placed in a background mode (e.g., so that the same chair that was previously being used as an anchor can continue to be correlated with the same anchor).

In accordance with one or more implementations, the electronic device 105 (e.g., the OS service 200) may store, for each of one or more applications that are in a background mode, a subset of the updates to the physical environment information that occur while that application is in the second mode. The electronic device 105 (e.g., the OS service 200) may then provide the subset of the updates that is stored for an application, to that application, responsive to determining that that application has entered an active mode. In one or more implementations, the OS service 200 may monitor the state of applications, such as the application 202, the application 204, the application 206, and/or any other applications running on the electronic device for transitions between active (e.g., foreground) and inactive (e.g., background) modes. The OS service 200 may begin storing updates for an application when the application is determined to have entered a background mode, and may provide a subset of the updates that occur while the application is in the background mode to the application when the application is determined to have entered a foreground or active mode. The OS service 200 may compact the stored updates to form the subset of the updates (e.g., in an ongoing manner) while the application is in the background state.

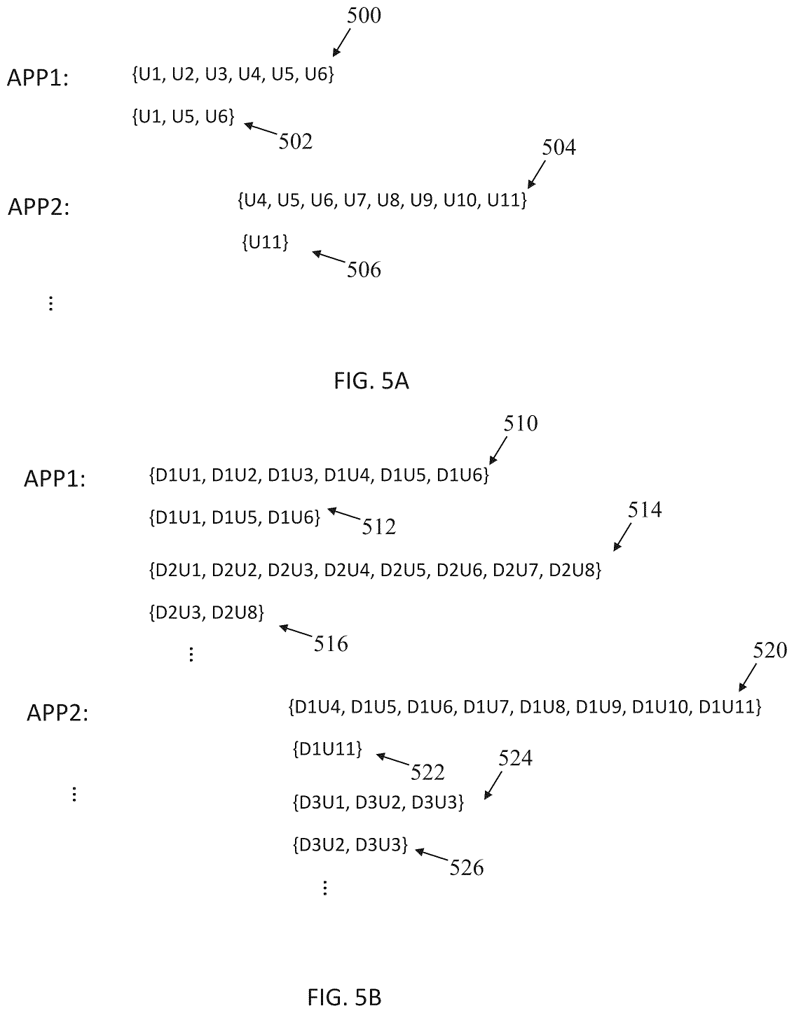

For example, FIG. 5A illustrates examples of subsets of updates to physical environment information that can be provided to an application when the application enters a foreground or active mode from a background mode or other inactive mode. In the example of FIG. 5A, a set of updates 500 (e.g., U1, U2 . . . ) is shown. The set of updates 500 may be a set of updates to physical environment information that corresponds to a current state of a physical environment of the electronic device 105, and that occur while a first application (e.g., APP1, such as application 202) is in a background state. For example, the first update, U1, may be a first update to the physical environment information that occurs after the first application enters a background mode. The subsequent updates, U2, U3, U4, U5, and U6, may occur after the first update, U1, and while the first application is in the background mode.

As examples, the updates, U1, U2, U3, U4, U5, and U6 may correspond to a change to an existing physical anchor object in the physical environment, an addition of a physical anchor object to the physical environment, or a removal of a physical anchor object from the physical environment. As example, a change to a physical anchor object in the physical environment may include a change in the location of the physical anchor object (e.g., as in the example of FIG. 4C), or another change to the physical anchor object (e.g., a change in the orientation of the physical anchor object, the lighting of the physical anchor object, a texture associated with the physical anchor object, or any other physical aspect of the physical anchor object).

FIG. 5A also illustrates a subset 502 of the set of updates 500. For example, the subset 502 may be generated by compacting the set of updates 500. For example, a particular update, such as the update U2, can become stale if a subsequent update, such as the update U5 supersedes the particular update. For example, the update U2 may represent a move of a physical anchor object from a first location to a second location, and the update U5 may represent a move of the physical anchor object from the second location to a third location. In this example, the update U2 may be determined to be a stale update, and may be removed, as illustrated by the subset 502. As another example, an update may be removed if a subsequent update cancels that update. For example, the update U3 in FIG. 5 may represent an addition of a new physical anchor object to the physical environment (e.g., a physical object that has been moved into the field of view of the electronic device 105 and detected by the electronic device 105), and the update U4 may represent a removal of the new physical anchor object (e.g., if the new physical object that was moved into the field of view of the electronic device 105 and detected by the electronic device 105 is later moved out of the field of view of the electronic device 105). In this example, the update U4 and the update U3 cancel each other, and both can be removed. In this example, the resulting subset 502 of the set of updates 500 that occurred while the first application was in the background mode includes only the updates U1, U5, and U6, which may be provided to the first application when the first application returns to an active or foreground mode.

FIG. 5A also illustrates how the electronic device 105 may store updates for more than one application in a background mode (e.g., a different or overlapping times), and generate a subset of the stored updates for more than one application. For example, as shown in FIG. 5A, a second application (e.g., APP2, such as the application 204 of FIG. 2) may enter a background mode (e.g., at the same time or at a different time from the time at which the first application entered the background mode). In the example of FIG. 5A, the second application enters the background mode at a time between the updates U3 and U4 that were also stored for the first application. In this example, a set of updates 504 occur while the second application is in the background mode, and a subset 506 of the set of updates 504 is generated (e.g., by compacting the set of updates 504 as discussed herein) for providing to the second application when the second application returns to an active or foreground mode. In the example of FIG. 5A, the subset 506 includes only the last update (e.g., U11) in the set of updates 504. This can occur, for example, if all of the updates U4-U10 cancel each other and/or a superseded by the update U11.

In the example of FIG. 5A, only a single set of updates, and a single corresponding subset of the updates is provided for each application in the background mode. However, it is also appreciated that each application running on an electronic device may subscribe to multiple types of physical environment information (e.g., scene reconstruction information, three-dimensional mesh information, physical anchor object information, object location information, object classification information, texture information, lighting information, and/or any other type of physical environment information that describes a physical aspect of a physical environment). For example, FIG. 5B illustrates an example in which the first application (e.g., APP1, such as the application 202) is subscribed to two types of physical environment information, labeled D1 and D2, and the second application (e.g., APP2, such as the application 204) subscribed to two types of physical environment information, labeled D1 and D3. In this example, the electronic device 105 (e.g., the OS service 200) stores, for the first application, a set of updates 510 (e.g., D1U1, D1U2, etc.) for the first type of data, and set of updates 514 (e.g., D2U1, D21U2, etc.) for the second type of data while the first application is in a background mode. In this example, the electronic device 105 (e.g., the OS service 200) compacts the set of updates 510 to form a subset 512 and compacts the set of updates 514 to form a subset 516. The subset 512 and the subset 516 may then be provided to the first application (e.g., by the OS service 200) when the first application returns to an active or foreground mode.

In the example of FIG. 5B, the electronic device 105 (e.g., the OS service 200) stores, for the second application, a set of updates 520 (e.g., D1U4, D1U5, etc.) for the first type of data, and a set of updates 524 (e.g., D3U1, D3U2, etc.) for the third type of data while the second application is in a background mode. In this example, the electronic device 105 (e.g., the OS service 200) compacts the set of updates 520 to form a subset 522 and compacts the set of updates 524 to form a subset 526. The subset 522 and the subset 526 may then be provided to the second application (e.g., by the OS service 200) when the first application returns to an active or foreground mode.

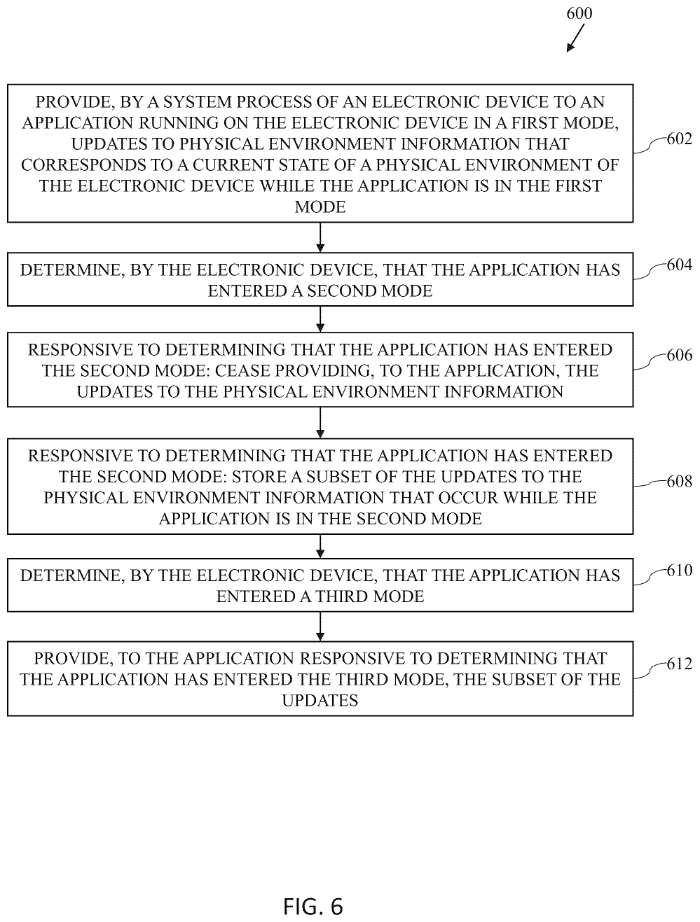

FIG. 6 illustrates a flow diagram of an example process for application state management according to aspects of the subject technology according to aspects of the subject technology. For explanatory purposes, the process 600 is primarily described herein with reference to the electronic device 105 of FIG. 1. However, the process 600 is not limited to the electronic device 105 of FIG. 1, and one or more blocks (or operations) of the process 600 may be performed by one or more other components of other suitable devices, including the electronic device 104, the electronic device 110, and/or the electronic device 115. Further, the blocks of process 600 are described herein as occurring in serial, or linearly. However, multiple blocks of process 600 may occur in parallel. In addition, the blocks of process 600 need not be performed in the order shown and/or one or more blocks of process 600 need not be performed and/or can be replaced by other operations.

In the example of FIG. 6, at block 602, an electronic device (e.g., electronic device 105) may provide, (e.g., by a system process of the electronic device, such as the OS service 200 of FIG. 2) to an application (e.g., application 202) running on the electronic device in a first mode (e.g., an active mode or a foreground mode), updates to physical environment information that corresponds to a current state of a physical environment (e.g., physical environment 300) of the electronic device while the application is in the first mode. For example, the updates may be updates to one or more physical objects, meshes, textures, lighting information, and/or other physical attributes of the physical environment at the current time. While the application is in the active mode, the application may generate application data (e.g., virtual content) for display based on the updates to the physical environment information.

At block 604, the electronic device (e.g., the system process) may determine that the application has entered a second mode. For example, the first mode may be a foreground mode or an active mode, and the second mode may be a background mode, an inactive mode, or a terminated mode. The application may enter the second mode when a user of the electronic device selects another application for an active mode, or otherwise sends the application to a background mode (e.g., by minimizing, docking, or closing a UI of the application).

At block 606, responsive to determining that the application has entered the second mode, the electronic device (e.g., the system process) may cease providing, to the application, the updates to the physical environment information. For example, a system process (e.g., the OS service 200) at the electronic device may continue to maintain a global state of the physical environment (e.g., a list and/or properties of one or more physical objects, meshes, textures, lighting information, and/or other physical attributes of the physical environment at the current time), but may discontinue providing any updates regarding the state of the physical environment to the application.

At block 608, responsive to determining that the application has entered the second mode, the electronic device (e.g., the system process) may store a subset (e.g., the subset 502, the subset 512, or the subset 516) of the updates to the physical environment information that occur while the application is in the second mode (e.g., the set of updates 500, the set of updates 510, or the set of updates 514).

In one or more implementations, the electronic device may store subsets of the updates for multiple applications in the second mode (e.g., at the same or different times, as described herein in connection with FIG. 5A), and/or for multiple types of physical environment information (e.g., as described herein in connection with FIG. 5B). For example, storing the subset of the updates to the physical environment information that occur while the application is in the second mode may include storing the subset of the updates to the physical environment information that occur while the application is in the second mode for the application, and the electronic device may also, while the application and a second application (e.g., application 204 or application 206) at the electronic device are in the second mode, store, for the second application, a second subset (e.g., the subset 506, the subset 516, or the subset 526) of the updates to the physical environment information.

As another example, the subset of the updates to the physical environment information that occur while the application is in the second mode may include a first subset (e.g., the subset 512) of the updates corresponding to a first portion of the physical environment information, and a second subset (e.g., the subset 516) of the updates corresponding to a second portion of the physical environment information. In one or more implementations, the updates to the physical environment information may include updates corresponding to one or more of (as examples): a change in a location of a physical object (e.g., the physical table 312, the physical chair 314, or the physical wall 301 of FIG. 3, such as due to motion of the physical object and/or motion of the electronic device relative to the physical object) in the physical environment, a notification of removal of a physical object from the physical environment, a notification of an addition of a new physical object to the physical environment, or a update to a mesh and/or scene understanding data generated by the electronic device to represent the physical environment. In one example, the first portion of the physical environment information (corresponding to the first subset of the updates) may include the location of the physical object in the physical environment, and the second portion of the physical environment information (corresponding to the second subset of the updates) may include the mesh generated by the electronic device to represent the physical environment.

In one or more implementations, storing the subset of the updates to the physical environment information at block 608 may include storing a set of the updates (e.g., the set of updates 500, the set of updates 510, or the set of updates 514) to the physical environment information that occur while the application is in the second mode; and compacting, while the application is in the second mode, the stored set of the updates to the physical environment information that occur while the application is in the second mode to form the subset (e.g., the subset 502, the subset 512, or the subset 516, as described herein in connection with FIGS. 5A and 5B).

For example, compacting the stored set of updates may include at least one of: removing one of the updates from the stored set of updates or combining two or more of the updates in the set of updates (e.g., two or more of the updates in which one of the updates supersedes one or more other updates, or in which one of the updates cancels on or more other updates).

In one or more implementations, compacting the stored set of the updates to the physical environment information may include periodically compacting a first portion of the set of updates, and compacting a second portion of the set of updates (e.g., opportunistically) during an inactive state of the electronic device (e.g., when the electronic device is in a sleep mode or an off mode). For example, the first portion of the updates may be updates that occur responsive to an event in the physical environment, such as a move or change to a physical object, an addition or removal of a physical object in the physical environment, or an update to mesh corresponding to the physical environment. For example, the second portion of the updates may be updates that occur in real time, such as updates to pass-through video, hand location data, gesture detection data, viewpoint correction data, or the like.

At block 610, the electronic device (e.g., the system process) may determine that the application has entered a third mode. The third mode may be the same as the first mode, or may be different from the first mode. For example, the first mode may be an active mode, and the second mode may be a background mode. The third mode may be the same active mode or may be a different active mode as the first mode.

At block 612, the electronic device (e.g., the system process) may provide, to the application responsive to determining that the application has entered the third mode, the subset of the updates. In one or more implementations, the electronic device may also provide, for display while the application is in the first mode, a user interface (e.g., the user interface 304 or an element thereof, such as the virtual content 400 of FIG. 4A) of the application. The electronic device may also provide, for display while the application is in the third mode, the user interface with at least one modification that is based on the subset of the updates to the physical environment information (e.g., as described herein in connection with FIG. 4D).

In one or more implementations, the process 600 may also include determining (e.g., by the OS service 200) that a second application (e.g., application 204 or application 206) running on the electronic device is in the first mode while the application is in the second mode. The electronic device may also provide, to the second application while storing the subset of the updates to the physical environment information that occur while the application is in the second mode, the updates to the physical environment information that occur while the application is in the second mode to the second application. The electronic device (e.g., the OS service 200) may also determine that the second application has entered the second mode. Responsive to determining that the second application has entered the second mode: the electronic device (e.g., the OS service 200) may cease providing, to the second application, the updates to the physical environment information; and store, for the second application, a second subset of the updates (e.g., the subset 506, the subset 516 or the subset 526) to the physical environment information that occur while the second application is in the second mode.

As described above, aspects of the subject technology may include the collection of data. The present disclosure contemplates that in some instances, this collected data may include personal information data that uniquely identifies or can be used to identify a specific person. Such personal information data can include demographic data, location-based data, online identifiers, telephone numbers, email addresses, home addresses data, image data, audio data, environment data, or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for application state management for electronic devices. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of application state management for electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 7 illustrates an example computing device with which aspects of the subject technology may be implemented in accordance with one or more implementations. The computing device 700 can be, and/or can be a part of, any computing device or server for generating the features and processes described above, including but not limited to a laptop computer, a smartphone, a tablet device, a wearable device such as a goggles or glasses, and the like. The computing device 700 may include various types of computer readable media and interfaces for various other types of computer readable media. The computing device 700 includes a permanent storage device 702, a system memory 704 (and/or buffer), an input device interface 706, an output device interface 708, a bus 710, a ROM 712, one or more processing unit(s) 714, one or more network interface(s) 716, and/or subsets and variations thereof.

The bus 710 collectively represents all system, peripheral, and chipset buses that communicatively connect the numerous internal devices of the computing device 700. In one or more implementations, the bus 710 communicatively connects the one or more processing unit(s) 714 with the ROM 712, the system memory 704, and the permanent storage device 702. From these various memory units, the one or more processing unit(s) 714 retrieves instructions to execute and data to process in order to execute the processes of the subject disclosure. The one or more processing unit(s) 714 can be a single processor or a multi-core processor in different implementations.

The ROM 712 stores static data and instructions that are needed by the one or more processing unit(s) 714 and other modules of the computing device 700. The permanent storage device 702, on the other hand, may be a read-and-write memory device. The permanent storage device 702 may be a non-volatile memory unit that stores instructions and data even when the computing device 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 714 may need at runtime. In one or more implementations, the processes of the subject disclosure are stored in the system memory 704, the permanent storage device 702, and/or the ROM 712. From these various memory units, the one or more processing unit(s) 714 retrieves instructions to execute and data to process in order to execute the processes of one or more implementations.

The bus 710 also connects to the input and output device interfaces 706 and 708. The input device interface 706 enables a user to communicate information and select commands to the computing device 700. Input devices that may be used with the input device interface 706 may include, for example, alphanumeric keyboards and pointing devices (also called “cursor control devices”). The output device interface 708 may enable, for example, the display of images generated by computing device 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 710 also couples the computing device 700 to one or more networks and/or to one or more network nodes through the one or more network interface(s) 716. In this manner, the computing device 700 can be a part of a network of computers (such as a LAN, a wide area network (“WAN”), or an Intranet, or a network of networks, such as the Internet. Any or all components of the computing device 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
providing, by an electronic device to an application running on the electronic device in a first mode, updates to physical environment information that corresponds to a current state of a physical environment of the electronic device while the application is in the first mode;
determining, by the electronic device, that the application has entered a second mode;
responsive to determining that the application has entered the second mode:
ceasing providing, to the application, the updates to the physical environment information; and
storing a subset of the updates to the physical environment information that occur while the application is in the second mode;
determining, by the electronic device, that the application has entered a third mode; and
providing, to the application responsive to determining that the application has entered the third mode, the subset of the updates.

2. The method of claim 1, further comprising:
providing, for display while the application is in the first mode, a user interface of the application; and
providing, for display while the application is in the third mode, the user interface with at least one modification that is based on the subset of the updates to the physical environment information.

3. The method of claim 1, wherein the third mode is the same as the first mode.

4. The method of claim 1, wherein the first mode is an active mode, and wherein the second mode is a background mode.

5. The method of claim 1, further comprising:
determining that a second application running on the electronic device is in the first mode while the application is in the second mode; and
providing, to the second application while storing the subset of the updates to the physical environment information that occur while the application is in the second mode, the updates to the physical environment information that occur while the application is in the second mode to the second application.

6. The method of claim 5, further comprising:
determining, by the electronic device, that the second application has entered the second mode; and
responsive to determining that the second application has entered the second mode:
ceasing providing, to the second application, the updates to the physical environment information; and
storing, for the second application, a second subset of the updates to the physical environment information that occur while the second application is in the second mode.

7. The method of claim 1, wherein storing the subset of the updates to the physical environment information that occur while the application is in the second mode comprises storing the subset of the updates to the physical environment information that occur while the application is in the second mode for the application, the method further comprising:
while the application and a second application at the electronic device are in the second mode, storing, for the second application, a second subset of the updates to the physical environment information.

8. The method of claim 1, wherein the subset of the updates to the physical environment information that occur while the application is in the second mode comprises:
a first subset of the updates corresponding to a first portion of the physical environment information; and
a second subset of the updates corresponding to a second portion of the physical environment information.

9. The method of claim 8, wherein the updates to the physical environment information include updates corresponding to one or more of: a change in a location of a physical object in the physical environment, a notification of removal of a physical object from the physical environment, a notification of an addition of a new physical object to the physical environment, or a update to a mesh generated by the electronic device to represent the physical environment.

10. The method of claim 9, wherein the first portion of the physical environment information comprises the location of the physical object in the physical environment, and wherein the second portion of the physical environment information comprises the mesh generated by the electronic device to represent the physical environment.

11. The method of claim 1, wherein storing the subset of the updates to the physical environment information comprises:
storing a set of the updates to the physical environment information that occur while the application is in the second mode; and
compacting, while the application is in the second mode, the stored set of the updates to the physical environment information that occur while the application is in the second mode to form the subset.

12. The method of claim 11, wherein compacting the stored set of updates comprises at least one of: removing one of the updates from the stored set of updates or combining two or more of the updates in the set of updates.

13. The method of claim 11, wherein compacting the stored set of the updates to the physical environment information comprises:
periodically compacting a first portion of the set of updates; and
compacting a second portion of the set of updates during an inactive state of the electronic device.

14. A device, comprising:
a memory; and
one or more processors configured to:
provide, to an application running on the device in a first mode, updates to physical environment information that corresponds to a current state of a physical environment of the device while the application is in the first mode;
determine that the application has entered a second mode;
responsive to determining that the application has entered the second mode:
cease providing, to the application, the updates to the physical environment information; and
store a subset of the updates to the physical environment information that occur while the application is in the second mode;
determine that the application has entered a third mode; and
provide, to the application responsive to determining that the application has entered the third mode, the subset of the updates.

15. The device of claim 14, wherein the one or more processors are further configured to:
provide, for display while the application is in the first mode, a user interface of the application; and
provide, for display while the application is in the third mode, the user interface with at least one modification that is based on the subset of the updates to the physical environment information.

16. The device of claim 14, wherein the first mode and the third mode are active modes, and wherein the second mode is a background mode.

17. The device of claim 14, wherein the one or more processors are further configured to:
determine that a second application running on the device is in the first mode while the application is in the second mode; and
provide, to the second application while storing the subset of the updates to the physical environment information that occur while the application is in the second mode, the updates to the physical environment information that occur while the application is in the second mode to the second application.

18. The device of claim 14, wherein the one or more processors are configured to store the subset of the updates to the physical environment information by:
storing a set of the updates to the physical environment information that occur while the application is in the second mode; and
compacting, while the application is in the second mode, the stored set of the updates to the physical environment information that occur while the application is in the second mode to form the subset.

19. A non-transitory, computer-readable medium storing instructions which, when executed by one or more processors, cause the one or more processors to perform operations comprising:
providing, by an electronic device to an application running on the electronic device in a first mode, updates to physical environment information that corresponds to a current state of a physical environment of the electronic device while the application is in the first mode;
determining, by the electronic device, that the application has entered a second mode;
responsive to determining that the application has entered the second mode:
ceasing providing, to the application, the updates to the physical environment information; and
storing a subset of the updates to the physical environment information that occur while the application is in the second mode;
determining, by the electronic device, that the application has entered a third mode; and
providing, to the application responsive to determining that the application has entered the third mode, the subset of the updates.

20. The non-transitory, computer-readable medium of claim 19, wherein the operations further comprise:
providing, for display while the application is in the first mode, a user interface of the application; and
providing, for display while the application is in the third mode, the user interface with at least one modification that is based on the subset of the updates to the physical environment information.
